(19) United States
(12) Patent Application Publication
(10) Pub. No.: US 2015/0013177 A1
(43) Pub. Date: Jan. 15, 2015

(54) Curing System and Method

(71) Applicant: Finishing Brands Holdings Inc., Minneapolis, MN (US)

(72) Inventors: Frank S. Villella, III, Blaine, MN (US); Scott J. Anderson, Vadnais Heights, MN (US); Gary P. Metzger, Big Lake, MN (US); Jerold R. Smisek, Andover, MN (US)

(21) Appl. No.: 14/320,170

(22) Filed: Jun. 30, 2014

Related U.S. Application Data
(60) Provisional application No. 61/846,535, filed on Jul. 15, 2013.

(51) Int. Cl. F26B 3/30; F26B 23/04

(52) U.S. Cl. CPC F26B 3/30; F26B 23/04
USPC 34/269; 34/266

(57) ABSTRACT

A system including a curing system, including a first heating section, wherein the first heating section is configured to heat a device with a first radiant heat source, a second heating section coupled to the first heating section, wherein the second heating section is configured to heat the device with a second radiant heat source, and a controller system, configured to control the first and second heating sections based on a thermal curing profile for the device.

### CROSS-REFERENCE TO RELATED APPLICATION

This Application is a Non-Provisional Application and claims priority to U.S. Provisional Patent Application No. 61/846,535, entitled “Curing System and Method”, filed Jul. 15, 2013, which is herein incorporated by reference.

### BACKGROUND

The invention relates generally to a curing system and method.

The medical field uses devices for different applications including patient treatments and disease detection. Some of these devices may include special coatings that facilitate use of a device or enable a device to perform a specific task. However, some of these coatings may be sensitive to specific parameters during coating and curing.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system including a curing system, including a first heating section, wherein the first heating section is configured to heat a device with a first radiant heat source, a second heating section coupled to the first heating section, wherein the second heating section is configured to heat the device with a second radiant heat source, and a controller system, configured to control the first and second heating sections based on a thermal curing profile for the device.

In another embodiment, system including a heating system, including a first heating section, wherein the first heating section is configured to heat a device with a first radiant heat source, a second heating section coupled to the first heating section, wherein the second heating section is configured to heat the device with a second radiant heat source, and a cooling system coupled to the heating system; and a controller system, configured to control the first heating section, the second heating section, and the cooling system based on a thermal curing profile for the device.

In another embodiment, a method, including adjusting a first temperature of a first heating section based on a thermal curing profile of a coating, adjusting a second temperature of a second heating section based on the thermal curing profile of the coating, adjusting a speed of a conveyor to move a device along a path through the first and second heating sections, and monitoring the first and second temperatures to control curing of the coating.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic top view of an embodiment of a curing system;

FIG. 2 is a cross-sectional view of an embodiment of a first heating section along line 2-2 of FIG. 1;

FIG. 3 is a cross-sectional view of an embodiment of a first heating section along line 2-2 of FIG. 1;

FIG. 4 is a cross-sectional view of an embodiment of a first heating section along line 2-2 of FIG. 1;

FIG. 5 is a cross-sectional view of an embodiment of a second heating section along line 5-5 of FIGS. 1; and

FIG. 6 is a flowchart of an exemplary method for controlling the heating system of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed towards a curing system and associated methods for controlling the curing system. The curing system may cure friction reducing coatings, protective coatings, sanitizing coatings, color coatings (e.g., paints), clear coatings, elastomeric coatings, silicone coatings, rubber coatings, polymeric coatings, drug coatings, biocompatible coatings, etc. These coatings may be temperature sensitive with specific thermal curing profiles (i.e., wherein a particular temperature(s) over a period(s) of time cures a particular coating). The coatings may be applied to medical devices (e.g., needles, stents, catheters, or any non-medical heat sensitive device which requires precise temperature control) to facilitate use and/or operation. Depending on the type of coating, the thermal curing profile (i.e., temperature(s) vs. time) may be linear, curved, stepped, or any combination thereof. For example, in some embodiments, the thermal curing profile of a coating may entail rapidly heating a device to a first temperature and then maintaining that temperature for a specific amount of time. In some embodiments, the thermal curing profile may entail incrementally stepping the temperature over time (e.g., stepping the temperature higher and then lower, stepping the temperature higher and then maintaining the temperature). In some embodiments, the thermal curing profile may entail linearly heating the device before maintaining a temperature.

To accommodate different thermal curing profiles, the curing system may include a heating system with two more heating sections (e.g., 2, 3, 4, 5, 6, 7, 8, 9, 10 or more sections). Indeed, each of the heating sections may use different types of heat transfer (e.g., radiant, conduction, convection, or combinations thereof) to accommodate a coating's thermal curing profile. For example, in some embodiments, the heating system may include a first heating section capable of rapidly heating a device and/or coating to a first temperature, while a second heating section maintains the device/coating at the first temperature until the cure process is complete. In some embodiments, the first heating section may use a heating lamp to rapidly heat the device with radiation (e.g., thermal radiant or radiative heat transfer), while the second section maintains the temperature of the device with radiant thermal energy from platens (i.e., resistive metal plate heaters). In embodiments with more than two sections, the sections may alternate between different types of heating (e.g., radiant, convection), and/or the sections may form heating patterns (e.g., radiant, convection, radiant, etc.) to accommodate the different thermal heating profiles. Moreover, because the coatings may be temperature sensitive, the heating system may use temperature feedback from thermal sensors (e.g., thermocouples, pyrometers, and/or infrared cameras) that communicate with a controller system. The controller system may then use the feedback to control the power output (i.e., heat transfer) of the heating lamp and/or the platens. In some embodiments, the controller system may communicate with a cooling system capable of reducing the temperature of the first heating and/or second heating sections to maintain precise temperature control during a curing process.

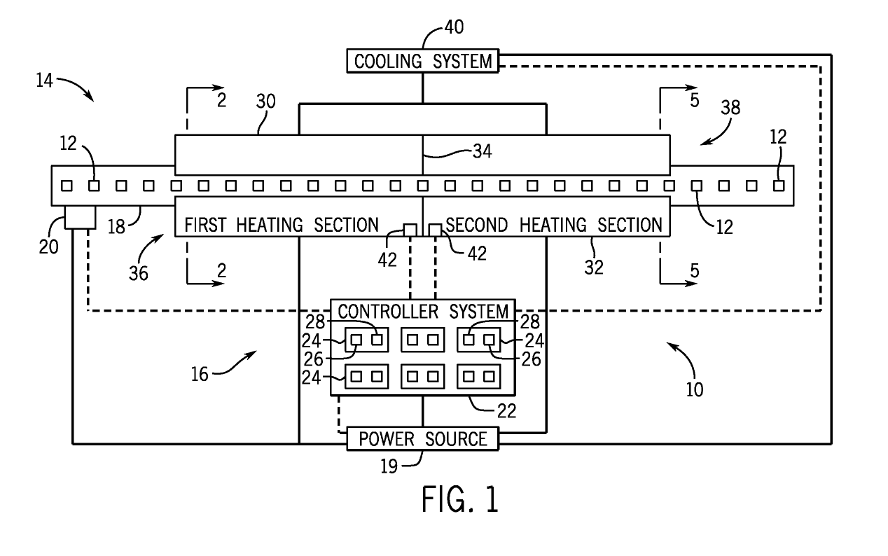

FIG. 1 is a schematic top view of a curing system 10 that enables precise temperature control. The precise temperature control may be useful in various applications such as curing, sanitizing, preparing a device for a coating, preparing a device for another process, etc. In the illustrated embodiment, the curing system 10 may be used to cure a coating (e.g., friction reducing coatings, protective coatings, sanitizing coatings, drug coatings, biocompatible coatings, etc.) on a device 12 (e.g., needles, stents, catheters, or any non-medical heat sensitive device which requires precise temperature control). The curing system 10 includes a conveyer system 14 that moves the devices 12 through a heating system 16. The conveyer system 14 includes a conveyer 18 and a motor 20 that receives power form a power source 19 to drive the conveyer 18. As illustrated, the devices 12 rest on the conveyer 18 that then moves the devices 12 through a heater system 16 with power from the motor 20. As the devices 12 pass through the heating system 20 the heating system uses power from the power source 19 to generate thermal energy that heats and/or cures coatings on the device 12. As explained above, some coatings and device substrates may be sensitive to temperature and time. Accordingly, the heater system 16 and the conveyer system 14 couple to a controller system 22 that controls operation of the curing system 10. The controller system 22 may include one or more controllers 24 that receive feedback and control the conveyer system 14, the heater 16 system, as well as other systems and components (e.g., a cooling system, heating sections, etc.) within the curing system 10. As illustrated, each of the controllers 24 includes a processor 26 and a memory 28. The memories 28 may store instructions (i.e., software code) executable by the processors 26 to control various operations within the curing system 10. For example, the controller system 22 may increase or decrease the temperature of the heating system 16 based on the characteristics (e.g., material composition, melting temperature, coating cure profile) of the coating and/or device. Moreover, the controller system 22 may adjust the coating cure time by varying the speed of the conveyer 18 (e.g., increasing, decreasing, or combinations thereof) via speed adjustments to the motor 20. The controller 16 may also adjust the speed of the conveyer 18 to account for production requirements.

The heating system 16 may include a first heating section 30 and a second heating section 32. As explained above, some embodiments may include additional sections (e.g., 2, 3, 4, 5, 6, 7, 8, 9, 10 or more heating sections). As illustrated, the first and second heating sections 30 and 32 may couple together at a connection point 34 to provide continuous heating of the device 12 from an inlet 36 to an outlet 38 of the heating system 16. If there are more than two sections, the additional sections may also couple together to provide continuous heating of the device 12 through the heating system 16 based on a production rate, cure profile, and/or heating profile.

The different heating sections 30 and 32 enable the curing system 10 to cure different coatings with different cure requirements (i.e., thermal curing profiles). The heating sections 30 and 32 may be configured to increase or decrease the temperature of the device 12 and/or coating at one or more equal or different rates (e.g., temperature vs. time curves), maintain the temperature of the device 12 or coating at one or more equal or different temperature levels, or a combination thereof. For example, the curing system 10 may use the first heating section 30 and the second heating section 32 to transfer heat differently or to heat a device to different temperatures. In one embodiment, the first heating section 30 may be a rapid heating section that heats the device 12 (e.g., medical device) to a target temperature, while the second heating section 32 may be used to maintain the device 12 at a target temperature. In some embodiments, the first section 24 may slowly increase the temperature of the device 12 to a first target temperature, while the second heating section 32 rapidly raises the temperature to a second target temperature. In another embodiment, the first heating section 30 may rapidly heat the device 12 to a first target temperature, after which the second heating section 32 rapidly heats the device 12 to a second target temperature. In still another embodiment, the first heating section 30 may raise the device 12 to a first target temperature and the second heating section 32 may gradually reduce the device 12 from a first target temperature to a second target temperature. Accordingly, the heat system 16 may accommodate different coatings with different cure requirements (i.e., thermal curing profiles).

The first heating section 30 and the second heating section 32 may also use different heat sources to transfer heat in different ways (e.g., convection, thermal radiation, conduction) to maintain target temperatures or for rapidly heating the devices 12. For example, to rapidly heat the device 12 to a precise target temperature one or both of the heating sections 30 and 32 may use infrared lamps. The infrared lamps enable rapid heating of the device 12 to a target temperature through infrared thermal radiation. Moreover, the first and second heating sections 30 and 32 may also use platens (e.g., resistive metal plate heaters) to heat or maintain precise target temperatures. As will be explained in more detail below, some embodiments may use a combination of infrared lamps and platens to heat and maintain the device 12 at a target temperature. Furthermore, the curing system 10 may include a cooling system 40 and thermal sensors 42 (e.g., thermocouples, infrared camera, pyrometers) to assist in maintaining precise temperature control of the first and second heating sections 30 and 32; and/or the device 12. For example, during operation, the first and second heating sections 30 and 32 may provide a thermal output that increases the temperature of the device 12 above a target temperature. Accordingly, the controller system 22 may use feedback from the thermal sensors 42 to control power output by the first and second heating sections 30 and 32; and/or cooling of the first and second heating sections 30 and/or 32 with the cooling system 40 to maintain precise temperature control of the device 12 and/or the first and second heating sections 30 and 32.

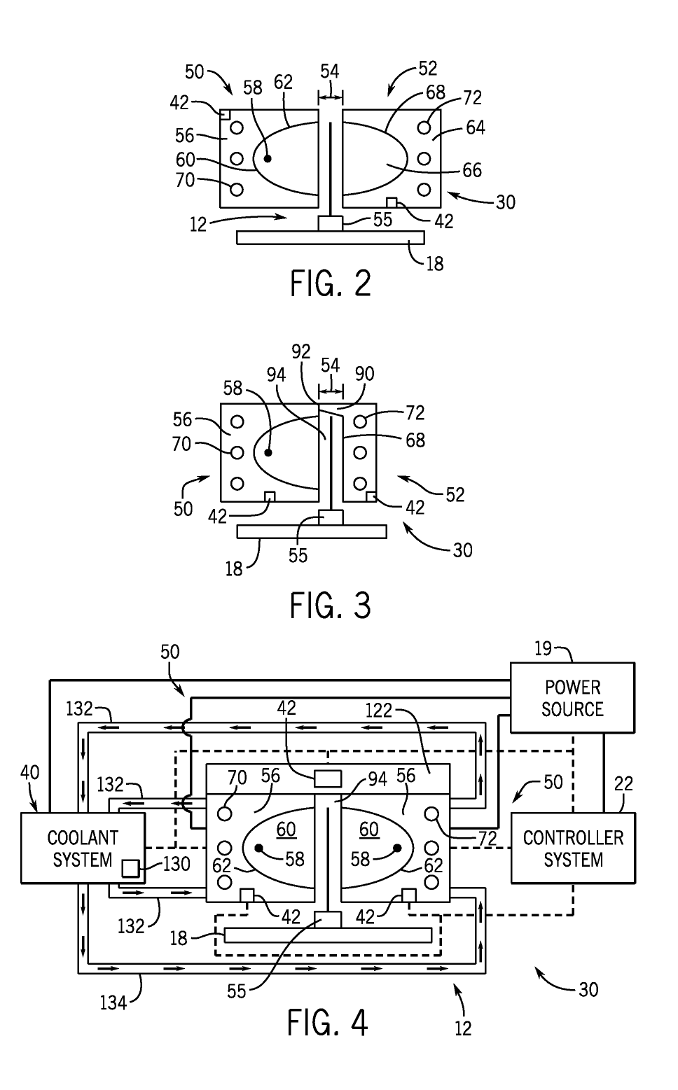

FIG. 2 is a cross-sectional view of the first heating section 30 along line 2-2 of FIG. 1. As illustrated, the first heating section 30 includes a heater 50 and a reflector 52. The heater 50 and reflector 52 are separated by a distance 54 to provide sufficient space for the device 12 to pass through the first heating section 30. In the illustrated embodiments, the device 12 may be a small medical device, such as a needle, stent, or catheter, with a coating. As explained above, the conveyer 18 moves the device 12 through the first and second heating sections 30 and 32 to cure the coating. The device 12 may be secured to the conveyer 18 with a small hub or container 55 to ensure proper orientation and positioning through the curing system 10.

The heater 50 may include a housing 56 with an infrared heat source 58. The infrared heat source 58 outputs short, medium, and/or long wave infrared radiation to rapidly heat the device 12 to a precise temperature, as the conveyer 18 carries the device 12 through the first heating section 30. In the present embodiment, the infrared heat source 58 rests within a cavity 60 of the housing 56. As illustrated, the cavity 60 may be parabolic or elliptical in shape to focus the infrared thermal radiation towards the device 12. Moreover, the cavity surface 62 may also be polished or include coatings that increase reflection of the thermal radiation from the infrared heat source 58 to the device 12. For example, the cavity surface 62 may be a polished metal (e.g., aluminum, gold, stainless steel) or the cavity surface 62 may be lined with a coating (e.g., gold, aluminum, stainless steel) that reflects the thermal radiation towards the device 12. The reflector 52 similarly includes a housing 52 with a cavity 60. The reflector cavity 64 may include a reflector surface 68 that is parabolic, elliptical, concave, or generally curved; covered with a reflective material; and/or polished to reflect infrared thermal radiation towards the device 12. In operation, the temperature of the heater 50 and reflector 52 may increase above a target temperature. Accordingly, in some embodiments, the heater 50 and the reflector 52 may include respective cooling apertures 70 and 72 that enable a cooling medium (e.g., liquid or gas) to cool the housing 56 and/or the reflector housing 64. The ability to cool the housing 56 and the reflector housing 64 enables precise temperature control of the first heating section 30, thus blocking over or under heating of a coating or the device 12.

FIG. 3 is a cross-sectional view of a first heating section 30 along line 2-2 of FIG. 1. In the illustrated embodiment, the reflector 52 includes a flat reflective surface 68 instead of a parabolic or elliptical surface. However, the flat reflective surface 68 may also be polished or include coatings that increase reflection of the thermal radiation from the infrared heat source 58 to the device 12. As illustrated, the reflector 52 in FIG. 3 includes a protrusion 90 that extends from the reflector surface 68 to the housing 56. Specifically, the protrusion 90 extends the distance 54 from the reflector surface 68 to a lamp housing surface 92 to form a chamber 94. The chamber 94 improves temperature control of the device 12 by reducing or blocking external heat transfer from sources or sinks outside of the first heating section 30, thus enabling more precise temperature control of the device 12.

FIG. 4 is a cross-sectional view of the first heating section 30 along line 2-2 of FIG. 1. In the illustrated embodiment, the first heating section 30 includes two heaters 50 opposite one another. In other embodiments, there may be only one heater 50 opposite a reflector 52. The heaters 50 include respective infrared heat sources 58 that enable rapid heating of the device 12 to a precise temperature. In the present embodiment, each infrared heat source 58 rests within a respective cavity 60. As explained above, these cavities 60 may be parabolic or elliptical and may be polished or include coatings that increase reflection of thermal radiation from the infrared heat sources 58 toward the device 12. However, in some embodiments, the cavities 60 may form other shapes or in some embodiments there may not be a cavity 60, but instead a flat reflective surface. To detect the temperatures within the cavities 60, in the housings 56, or of the device 12 the first heating section 30 may include thermal sensors 42 (e.g., thermocouples, infrared cameras, pyrometers). The thermal sensors 42 provide feedback to the controller system 22 enabling precise temperature control within the first heating section 30. Moreover, the heaters 50 may also include respective cooling apertures 70 and 72 that enable the coolant system 34 to drive a cooling medium (e.g., gas or liquid) through the housings 56. The cooling system 40 may be open or closed circuit and may include various components (e.g., a heat exchanger, refrigeration system, valves, pumps, fans, etc.). The coolant system 34 may drive a cooling medium through the first heating section 30 in response to the temperature measurement by the thermal sensors 42. In some embodiments, a plate 122 couples to the heaters 50 to form a chamber 94, which reduces or blocks external heat transfer from sources or sinks outside of the first heating section 30, thus enabling more precise temperature control of the device 12. Depending on the embodiment, the plate 122 may be heated (e.g., a platen) and/or a reflector. In embodiments with an unheated plate 122, the plate 122 may be formed out of a thermally resistant material that blocks or reduces heat transfer. In some embodiments, the plate 122 may receive one or more thermal sensors 42 (e.g., an infrared camera, thermocouple, pyrometer) to enable temperature detection of the chamber 94 and/or the actual temperature of the device 12.

The controller system 22 controls coat curing on the device 12 by managing the first heating section 30, the coolant system 34, and the conveyer system 14 with feedback from one or more thermal sensors 42. In operation, the controller system 22 executes instructions that cause the conveyor 18 to move the device 12 through the first heating section 30. As the conveyer 18 moves the devices 12 through the first heating section 30, the controller system 22 controls power output (i.e., heat transfer) from the infrared heat source 58 towards the devices 12. Specifically, the controller system 22 may execute instructions that provide a specific power output from the infrared heat sources 58 to heat the device 12 to a precise temperature for curing a specific coating. As explained above, the coating or device 12 may be a sensitive to temperature variations outside of a specific range. Accordingly, the controller system 22 may use the thermal sensors 42 separately or together to monitor changes in temperature of the device 12, the coating, the housing 56, etc. For example, the controller system 22 may use the infrared camera or pyrometer to monitor the temperature of the devices 12 and adjust the power output from the infrared heat sources 58 or cooling by the cooling system 40 in response to the detected temperature. The controller system 22 may also use the thermal sensors 42 to monitor and control the temperature of the devices 12. For example, the controller system 22 may use the detected temperature of the housing 56 or the temperature of the cavity surface 62 with known values about the curing system 10 to determine if the device 12 is at the correct temperature. If the temperature is too low, the controller system 22 executes instructions to increase power output from the heaters 50 and/or reduce cooling by the cooling system 40. Similarly, if the temperature is too high the controller system 22 may execute instructions to reduce power output from the heaters 50 or to increase cooling of the housings 56 with the coolant system 34. As illustrated, the coolant system 34 fluidly couples to the heaters 50 (or in some embodiments reflectors 52) enabling the coolant system 34 to drive cooling medium through the cooling apertures 70 and 72. Depending on the embodiment, the coolant system 34 may include a fan or pump 130 that drives a cooling medium (e.g., gas or liquid) through the conduits 134. As the cooling medium flows through the heaters 50 or the reflectors 52, the cooling medium absorbs thermal energy enabling the controller system 22 to maintain precise temperature control within the first heating section 30.

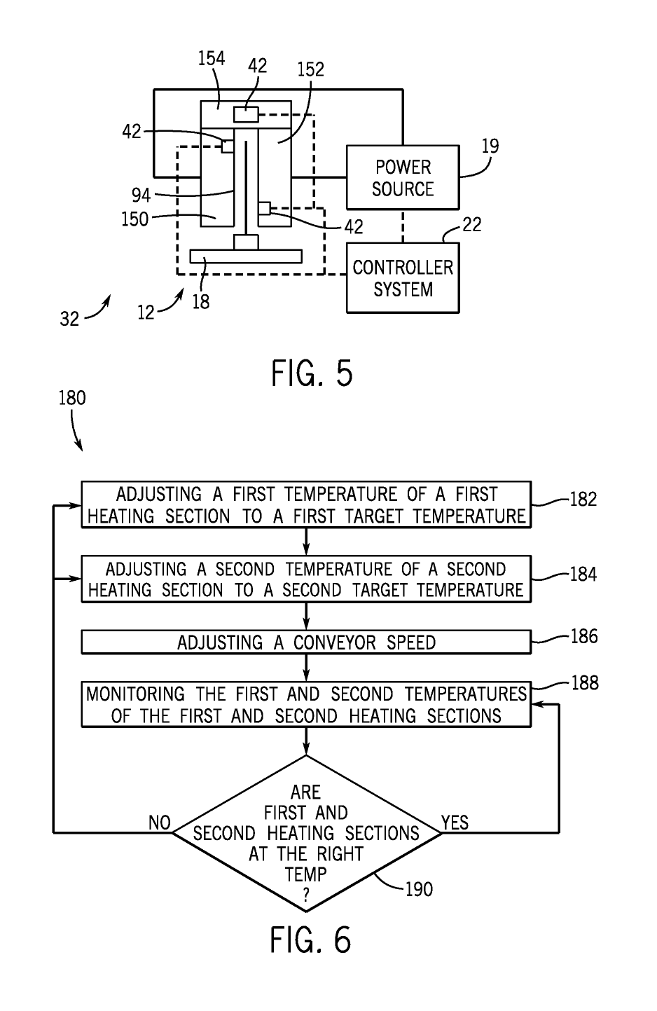

FIG. 5 is a cross-sectional view of the second heating section 32 along line 5-5 of FIG. 1. As explained above, the second heating section 32 couples to and works with the first heating section 30 to cure a coating on a device 12. In the illustrated embodiment, the second heating section 32 includes a first platen 150 (e.g., a resistive metal plate heater), a second platen 152, and a third plate/platen 154. In some embodiments, the second heating section 32 may include a heater 50 in combination with one or more platens. In some embodiments, the second heating section 32 may include a reflector 52 in combination with one or more platens. Furthermore, some embodiments of the second heating section 32 may not include a third platen 154. However, in the illustrated embodiment, the platens 150, 152, and 154 couple together to form a chamber 94, which reduces or blocks external heat transfer from sources or sinks outside of the second heating section 24. As illustrated, the first platen 150 and the second platen 152 couple to a power source 19 that provides an electrical current to the first and second platens 150 and 152. In some embodiments, the third plate/platen 154 couples to the power source 19 to provide additional heating. The first and second platens 150 and 152 are resistance heaters with metal plates that convert electrical current from the power source 19 into heat. As the first and second platens 150 and 152 receive power from the power source 19, the first and second platens 150 and 152 radiatively heat the device 12. In one embodiment, the convective heat in the second heating section 32 maintains the device 12 at substantially the same temperature that the device 12 was heated to in the first heating section 30. In some embodiments, the second heating section 32 may raise the temperature above the temperature in the first heating section 30. In another embodiment, the second heating section 32 may be at a lower temperature than the first heating section 30, thus enabling the device 12 to cool slightly but still facilitate coat curing.

In operation, the controller system 22 controls the heat produced by the first and second platens 150 and 152 with feedback from the thermal sensors 42 (e.g., the thermocouples, infrared cameras, pyrometers). As explained above, the controller system 22 includes multiple controllers 24 with processors 26 and memories 28. The memory(s) 28 may store instructions (i.e., software code) executable by the processor(s) 26 to control operation of the second heating section 32. Accordingly, the controller system 22 executes instructions that adjust the power output from the power source 19 to change the amount of heat produced by the first and second platens 150 and 152. During operation, the controller system 22 may use the thermal sensors 42 separately or together to monitor the temperature of the device 12; the platens 150, 152, and 154. For example, the controller system 22 may use the infrared camera or pyrometer to monitor the temperature of the devices 12 and, in response to the detected temperature, adjust the heat production by the first and second platens 150 and 152. The controller system 22 may also use the thermal sensors 42 to monitor and control the temperature of the device 12. For example, the controller system 22 may use the detected temperature of the first or second platens 150 and 152 to determine if the device 12 is at the correct temperature. Depending on the feedback, the controller system 22 may increase or decrease power output from the power source 19 to increase or decrease heat production by the platens 150 and 152. Accordingly, the second heat section 26 enables redundant temperature measurement and control for precise temperature control of the device 12 during the curing process.

FIG. 6 is a flowchart of an exemplary method 180 for controlling the heating system of FIG. 1. The method 180 begins with step 182, adjusting a temperature of the first heating section 30 to a first target temperature. As explained above, the first heating section 30 may be a rapid heating section that uses infrared heaters 50 to heat a device 12 to a precise temperature. Accordingly, the controller system 22 may adjust the power output of the heater 50 to heat the device 12 to the first target temperature. In step 184, the method 180 adjusts a temperature of the second heating section 32 to a second target temperature. As explained above, the second heating section 32 may radiatively heat the device 12 with platens. Depending on the embodiment, the second target temperature may be the same as or different from the first target temperature. In step 186, the controller system 22 adjusts the speed of the conveyer 18. The speed of the conveyer 18 may be based on the cure time for a particular type of coating (e.g., for longer cure times the controller system 22 will decrease the speed of the conveyer 18 or the controller system 22 may increase the speed of the conveyer 18 to decrease the cure time). In step 188, the controller system 22 monitors the first and second heating sections 30 and 32; and or the device 12 with one or more thermal sensors 42. In this manner, the controller system 22 ensures that the device 12 is heated to the correct temperature throughout the curing process. Finally, in step 190, the controller system 22 determines if the first and second heating sections 30 and 32; and/or the device 12 is at the first and second target temperatures. If the temperatures are correct, then the controller system 22 continues to monitor. If not, the controller system 22 returns to step 182 and/or step 184 to adjust the first and second target temperatures in the respective first and second heating sections 30 and 32. The steps in method 180 are not necessarily sequential steps, but may be performed simultaneously or in any order.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a curing system comprising:
a first heating section, wherein the first heating section is configured to heat a device with a first radiant heat source;
a second heating section coupled to the first heating section, wherein the second heating section is configured to heat the device with a second radiant heat source; and
a controller system, configured to control the first and second heating sections based on a thermal curing profile for the device.

2. The system of claim 1, wherein the first heating section comprises a reflector configured to reflect thermal radiation from the first radiant heat source.

3. The system of claim 2, wherein the reflector has a parabolic or elliptical reflector surface.

4. The system of claim 2, wherein the reflector comprises a polished metal.

5. The system of claim 1, wherein the first heating section comprises a space between the reflector and the first radiant heat source configured to receive the device.

6. The system of claim 1, wherein the first radiant heat source comprises an infrared heater.

7. The system of claim 1, comprising a cooling system configured to maintain a temperature of the first heating section at a threshold temperature.

8. The system of claim 1, wherein the curing system comprises a thermocouple, an infrared camera, or a pyrometer in communication with the controller system.

9. The system of claim 1, wherein the second heating section comprises a first heating platen.

10. The system of claim 9, wherein the second heating section comprises a second heating platen opposite the first heating platen.

11. A system comprising:
a heating system comprising:
a first heating section, wherein the first heating section is configured to heat a device with a first radiant heat source;
a second heating section coupled to the first heating section, wherein the second heating section is configured to heat the device with a second radiant heat source; and
a cooling system coupled to the heating system; and
a controller system, configured to control the first heating section, the second heating section, and the cooling system based on a thermal curing profile for the device.

12. The system of claim 11, wherein the first heating section comprises an infrared camera coupled to the controller system, wherein the controller system is configured to detect the temperature of a device or a coating.

13. The system of claim 11, wherein the second heating section comprises a thermocouple coupled to the controller system, wherein the thermocouple is configured to detect a temperature of a platen.

14. The system of claim 11, wherein the controller system is configured to control the cooling system and the heating system with feedback from one or more thermal sensors.

15. The system of claim 11, wherein the second heating section comprises first and second heating platens.

16. The system of claim 15, wherein the controller system controls heating of the first and second platens with feedback from one or more thermal sensors.

17. A method, comprising:
adjusting a first temperature of a first heating section based on a thermal curing profile of a coating;
adjusting a second temperature of a second heating section based on the thermal curing profile of the coating;
adjusting a speed of a conveyor to move a device along a path through the first and second heating sections; and
monitoring the first and second temperatures to control curing of the coating.

18. The method of claim 17, wherein the first heating section comprises a first radiant heat source.

19. The method of claim 17, wherein the second heating section comprises a second radiate heat source.

20. The method claim 17, wherein the first target temperature equals the second target temperature.
